(19) United States
(12) Patent Application Publication
(10) Pub. No.: US 2006/0227817 A1
(43) Pub. Date: Oct. 12, 2006

(54) Laser module for projecting a linear laser beam

(76) Inventor: Shih-Chang Chang, Sinhua Township (TW)

Correspondence Address: Raymond Sun, 12420 Woodhall Way, Tustin, CA, 92782, US

(21) Appl. No.: 11/165,369

(22) Filed: Jun. 22, 2005

(30) Foreign Application Priority Data
Apr. 8, 2005 (TW) 94111117

(51) Int. Cl. H01S 3/10

(52) U.S. Cl. 372/9

(57) ABSTRACT

A laser module includes a main body having a first end, a second end, and a bore connecting the first and second ends, the bore having a rotational axis that is transverse to the bore. The laser module also includes a laser beam generating device retained in the bore for producing a laser beam, a collimating lens installed in the bore between the first and second ends for collimating the laser beam into a parallel laser beam, a cylindrical lens for receiving the parallel laser beam and projecting a linear laser beam, and a cylindrical lens holder rotationally connected with the first end of the main body about the rotational axis of the bore. The cylindrical lens holder is pivoted about the rotational axis to adjust the inclination of the parallel laser beam directed onto the cylindrical lens.

### BACKGROUND OF THE INVENTION

1. Field of the Invention

The present invention relates to a laser module for projecting a linear laser beam, and in particular, to a laser module capable of adjusting the inclination of an incident laser beam projected onto a cylindrical lens so as to improve the linearity of the laser beam.

2. Description of the Prior Art

A laser beam has the characteristic of parallel transmission, and its illumination does not decrease drastically with transmission distance. Consequently, laser beams have been widely used in many applications for horizontal and vertical measurements in construction work. As an example, a laser module capable of projecting a linear laser beam on a target is often used as a laser source to measure the horizontal or vertical orientation of a level. Consequently, the linearity of the linear laser beam projected on a target is critical to the precision of the level.

FIG. 1 illustrates an “Adjustable Laser Module Device” 100 that is disclosed in Republic of China (Taiwan) Patent No. 202050, in which a laser beam generating module is installed in the rear end 112 of a hollow main body 110, and a cylindrical lens 120 is secured on the recess 116 of the front end 111 of the hollow main body 110 by screws 121 and 122 and an elastic optic mask 123. Also, two recesses 113 and 114 are provided in the hollow main body 110 on either side of the hollow main body 110 near the cylindrical lens 120. Two small connection parts 115 separately disposed on upper side and bottom side are disposed between the two recesses 113 and 114. Screws 121 and/or 122 are screwed against the front end 111 of the hollow main body 110 to adjust the inclination of the cylindrical lens 120, thereby adjusting the inclination of the incident laser beam generated by the laser module and directed at the cylindrical lens 120.

Although the laser module shown in FIG. 1 can adjust the inclination of an incident laser beam on to the cylindrical lens 120, and therefore achieve the goal of accurately projecting a linear laser beam from the device 100, the connection parts 115 of the hollow main body 110 will be subjected to residual stress after the adjustment. This residual stress will affect the precision of the linear laser beam projected by the device 100, and consequently compromise the precision of the level.

### SUMMARY OF THE INVENTION

It is an object of the present invention to provide a laser module for projecting a linear laser beam, where the laser module does not experience residual stress after the adjustment and can therefore maintain the precision of the projected linear laser beam.

In order to accomplish the objects of the present invention, the present invention provides a laser module that is capable of projecting a linear laser beam on a target, and where the inclination of a parallel laser beam directed at a cylindrical lens of the laser module can be adjusted. The laser module includes a main body having a first end, a second end, and a bore connecting the first and second ends, the bore having a rotational axis that is transverse to the bore. The laser module also includes a laser beam generating device retained in the bore for producing a laser beam, a collimating lens installed in the bore between the first and second ends for collimating the laser beam into a parallel laser beam, a cylindrical lens for receiving the parallel laser beam and projecting a linear laser beam, and a cylindrical lens holder rotationally connected with the first end of the main body about the rotational axis of the bore. The cylindrical lens holder is pivoted about the rotational axis to adjust the inclination of the parallel laser beam directed onto the cylindrical lens.

### BRIEF DESCRIPTION OF THE DRAWINGS

FIG. 1 is a perspective view of a conventional “Adjustable Laser Module Device”.

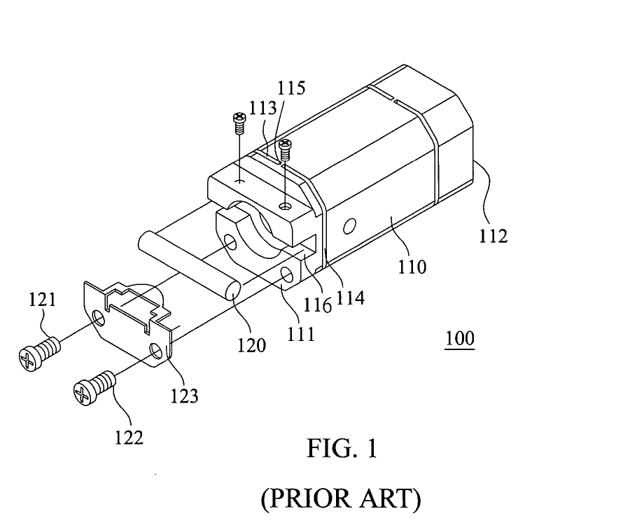

FIG. 2 is a perspective view of a laser module in accordance with one embodiment of the present invention.

FIG. 3 is an exploded perspective view of the laser module of FIG. 2.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

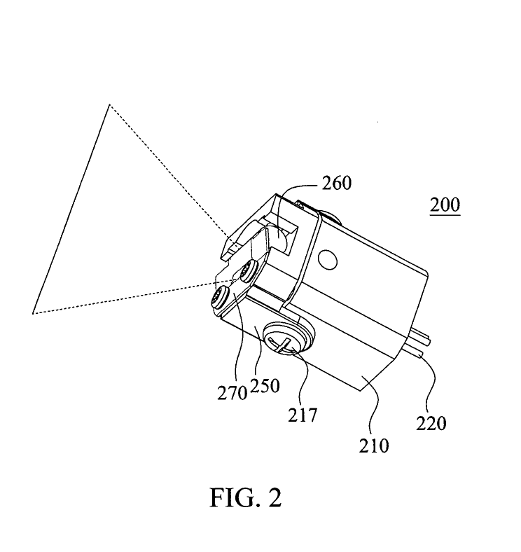

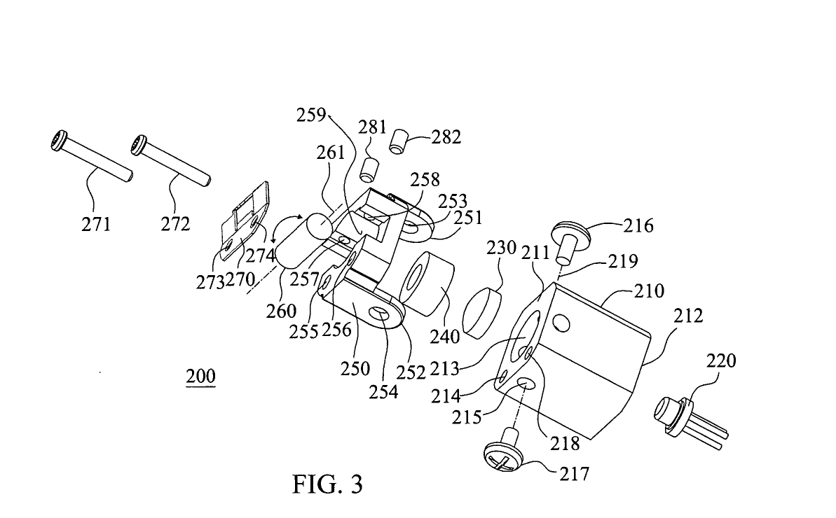

FIGS. 2 and 3 illustrate a laser module for projecting a linear laser beam in accordance with one embodiment of the present invention. The laser module for projecting a linear laser beam includes a main body 210, a laser beam generating device 220 (e.g., a laser diode), a collimating lens 230 (e.g., a convex lens), a collimating lens holder 240, a cylindrical lens holder 250, a cylindrical lens 260, and an elastic optic mask 270.

The main body 210 is a hollow, columnar structure having a bore 213 extending from the first end 211 through the second end 212. The laser beam generating device 220 functions to generate a laser beam, and is installed in the bore 213 from the second end 212 of the main body 210. The collimating lens 230 is first arranged in the collimating lens holder 240, which is then installed in the bore 213 from the first end 211 of the main body 210. The collimating lens 230 functions to collimate the laser beam generated from the laser beam generating device 220 into a parallel beam.

To project a linear laser beam on to a target, the parallel beam should then pass through the cylindrical lens 260 arranged on the cylindrical lens holder 250 so that the parallel beam can be refracted by the cylindrical lens 260 and projected as a linear laser beam. When the parallel beam is not perpendicular to the axial axis 261 of the cylindrical lens 260, the parallel beam will be refracted into a curvilinear laser beam (instead of the desired linear laser beam). On the other hand, when the parallel beam is perpendicular to the axial axis 261 of the cylindrical lens 260, the parallel beam will be refracted into a linear laser beam. Therefore, to improve the linearity of the projected linear laser beam, the cylindrical lens holder 250 should be able to adjust the axial axis 261 of the cylindrical lens 260 so as to make the incident parallel beam perpendicular to the axial axis 261 of the cylindrical lens 260.

As best shown in FIG. 3, two screw holes 215 are provided on the upper and lower periphery of the main body 210 adjacent the first end 211. The cylindrical lens holder 250 has two extensions 251 and 252, each carrying a respective opening 253 and 254 that are aligned with each other. The openings 253, 254 are also adapted to be aligned with the two screw holes 215 on the main body 210. Two screws 216 and 217 are adapted to be inserted through the openings 253 and 254 respectively, and then screwed into the two screw holes 215, with the screws 216, 217, the openings 253, 254 and the screw holes 215 defining a rotation axis 219. In other words, the cylindrical lens holder 250 uses the radial axis of the bore 213 of the main body 210 as its rotation axis 219 to rotationally (i.e., pivotably) connect with the first end 211 of the main body 210 so that the axial axis 261 of the cylindrical lens 260 arranged on the cylindrical lens holder 250 can be adjusted to make the incident parallel beam perpendicular to the axial axis 261 of the cylindrical lens 260. The rotation axis 219 is transverse to the longitudinal axis of the bore 213.

The cylindrical lens holder 250 has a space 259 for holding the cylindrical lens 260. The elastic optic mask 270 cooperates with the cylindrical lens holder 250 to define the space 259. Two screws 271 and 272 are used to secure the elastic optic mask 270 against the cylindrical lens 260 to retain the cylindrical lens 260 inside the space 259. In particular, the screws 271 and 272 are inserted through the through holes 273 and 274, respectively, on the elastic optic mask 270, through the screw holes 255 and 256, respectively, on the cylindrical lens holder 250, and then into the screw holes 214 and 218, respectively, on the main body 210. The sets of screw holes 255, 256 and 214, 218 are provided on either side of the rotation axis 219, and are aligned (e.g., screw holes 255 and 214 are aligned, and screw holes 256 and 218 are aligned). Consequently, the screws 271 and 272 can exert a force against the cylindrical lens holder 250, which in turn adjusts the inclination of the incident parallel beam directed on to the cylindrical lens 260, thereby improving the linearity of the projected linear laser beam. Furthermore, screws 281 and 282 are screwed into the screw holes 257 and 258, respectively, on the cylindrical lens holder 250, to press against the cylindrical lens 260 so as to maintain the horizontal orientation of the cylindrical lens 260 on the cylindrical lens holder 250.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A laser module capable of projecting a linear laser beam on a target, comprising:
a main body having a first end, a second end, and a bore connecting the first and second ends, the bore having a radial axis that is transverse to the bore;
a laser beam generating device retained in the bore for producing a laser beam;
a collimating lens installed in the bore between the first and second ends for collimating the laser beam into a parallel laser beam;
a cylindrical lens that receives the parallel laser beam and projects a linear laser beam; and
a cylindrical lens holder rotationally connected with the first end of the main body about the radial axis of the bore so as to adjust the inclination of the parallel laser beam directed on to the cylindrical lens.

2. The laser module of claim 1, wherein:
the first end of the main body has two opposing and aligned screw holes that extend at a direction transverse to the bore, and which define the radial axis,
the cylindrical lens holder has two extensions that are aligned with the screw holes, and
a screw is inserted through each aligned extension and screw hole.

3. The laser module of claim 1, wherein the collimating lens is a convex lens.

4. The laser module of claim 1, further comprising an elastic optic mask that secures the cylindrical lens on the cylindrical lens holder.

5. The laser module of claim 4, wherein:
the cylindrical lens holder has two screw holes extending therethrough,
the main body has two screw holes extending therethrough on both sides of the rotation axis, and
two screws are inserted through the elastic optic mask and then through the screws holes in the cylindrical lens holder and the main body, to secure the elastic optic mask to the cylindrical lens holder, and to adjust the inclination between the cylindrical lens holder and the longitudinal axis of the bore by pressing against the cylindrical lens holder.

6. The laser module of claim 1, wherein the laser beam generating device includes a laser diode.

7. The laser module of claim 1, wherein the laser beam generating device retained in the bore adjacent the second end of the bore.

8. A laser module capable of projecting a linear laser beam on a target, comprising:
a main body having a first end, a second end, and a bore connecting the first and second ends, the first end having two opposing and aligned screw holes that extend at a direction transverse to the bore, and which define a rotation axis;
a laser beam generating device retained in the bore for producing a laser beam;
a collimating lens installed in the bore between the first and second ends for collimating the laser beam into a parallel laser beam;
a cylindrical lens that receives the parallel laser beam and projects a linear laser beam;
a cylindrical lens holder having two extensions that are aligned with the screw holes; and
a screw that is inserted through each aligned extension and screw hole to rotationally connect the cylindrical lens holder with the first end of the main body along the rotation axis.

9. The laser module of claim 8, wherein the collimating lens is a convex lens.

10. The laser module of claim 8, further comprising an elastic optic mask that secures the cylindrical lens on the cylindrical lens holder.

11. The laser module of claim 10, wherein:
the cylindrical lens holder has two screw holes extending therethrough,
the main body has two screw holes extending therethrough on both sides of the rotation axis, and
two screws are inserted through the elastic optic mask and then through the screws holes in the cylindrical lens holder and the main body, to secure the elastic optic mask to the cylindrical lens holder, and to adjust the inclination between the cylindrical lens holder and the longitudinal axis of the bore by pressing against the cylindrical lens holder.

12. A method of adjusting the inclination of a parallel laser beam directed at a cylindrical lens of a laser module that is capable of projecting a linear laser beam on a target, comprising:
a. providing a laser module having:
a main body having a first end, a second end, and a bore connecting the first and second ends, the bore having a rotational axis that is transverse to the bore;
a laser beam generating device retained in the bore for producing a laser beam;
a collimating lens installed in the bore between the first and second ends for collimating the laser beam into a parallel laser beam;
a cylindrical lens for receiving the parallel laser beam and projecting a linear laser beam; and
a cylindrical lens holder rotationally connected with the first end of the main body about the rotational axis of the bore; and
b. pivoting the cylindrical lens holder about the rotational axis to adjust the inclination of the parallel laser beam directed onto the cylindrical lens.
